(19) United States
(12) Patent Application Publication
(10) Pub. No.: US 2025/0064219 A1
(43) Pub. Date: Feb. 27, 2025

(54) DOG RECUMBENCY REST ROCKER BED

(71) Applicant: Iowa State University Research Foundation, Inc., Ames, IA (US)

(72) Inventor: Rodney Steven Bagley, Stanhope, IA (US)

(21) Appl. No.: 18/810,980

(22) Filed: Aug. 21, 2024

Related U.S. Application Data
(60) Provisional application No. 63/520,974, filed on Aug. 22, 2023.

(51) Int. Cl. A47C 21/00; A01K 1/035; A47C 31/00

(52) U.S. Cl. CPC A47C 21/006; A01K 1/0353; A47C 31/008

(57) ABSTRACT

An oscillating/rotating/rocking bed provides movement to animals that may otherwise be fully or partially unable to move, such as due to injury or another malady. The oscillating/rotating/rocking motions of the bed encourage blood flow for the animal in an effort to stem off sores, structural issues, or even respiratory issues that can result from non-movement. The bed can activate various neural networks associated with proprioception, pressure, and touch as well as acupressure/acupuncture points and/or trigger points. The bed can provide surface and subsurface (deep) massage. The bed can move in more than one planar direction to best aid the animal. The movement can be in a rotational manner, wave-like manner, vibratory, vertical, planar, or generally any direction, and most often in multiple directions and/or planes to provide the most efficient manner of benefit for the animal.

### CROSS REFERENCE TO RELATED APPLICATIONS

This application claims priority under 35 U.S.C. § 119 to provisional patent application U.S. Ser. No. 63/520,974, filed Aug. 22, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to apparatuses, systems, and/or methods of use having application in at least the veterinary industry. More particularly, but not exclusively, the disclosure relates to apparatuses, systems, and/or methods for use in the care and recovery of animals, including dogs, having low movement ability.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Paralyzed and non-ambulatory animals often lie in a recumbent position for much if not all day until they recover the ability to move. For some animals, this recovery period can encompass weeks to months. This is equivalent to being “bed ridden” in human beings. Laying in a recumbent position for prolonged times, especially when unable to feel pain or move when uncomfortable, can result in a number of negative consequences that can impair functional recovery and even be life-threatening.

Examples include, but are not limited to, pressure damage (necrosis) to tissue creating “bed sores” (decubital ulcers), poor perfusion (lack of blood flow) of vital structures (i.e., nerves and muscles), and respiratory compromise (failure to inflate the lungs-atelectasis; and pneumonia). All of the listed issues stem from the inability of the animals to move one or more parts of their body. Currently, there is limited existing veterinary equipment to help prevent or mitigate the formation of sores or any of the other issues that may be caused by the non-movement of animals. This includes stimulation of peripheral sensory nervous system elements of pressure, proprioception, and touch, activation of acupressure/acupuncture and/or trigger points.

Thus, there exists a need in the art for an apparatus, systems, and/or methods which helps prevent body sores, improve blood flow, and activate/massage muscular/nerve issues that result from an animal's inability to move, such as from paralysis, injury, or another malady.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects of any of the embodiment of the present disclosure to stave off potential maladies caused by inactivity of animals to due illness, injury, or other condition. For example, if an animal, such as a dog, is paralyzed (either fully or partially) or otherwise injured, aspects of the disclosure may provide ways to move the dog to improve healing capabilities.

It is still yet a further object, feature, and/or advantage of any of the aspects of any of the embodiment of the present disclosure to provide gentle and continuous movement of an animal, such as by rocking a recumbent animal.

It is another object, feature, and/or advantage of any of the aspects of any of the embodiment to improve blood flow as well as stimulate the nervous, skin, and muscular/ligament/tendon systems of recumbent animals who may have difficulty or inability to move.

The apparatus, system, and/or method disclosed herein can be used in a wide variety of applications. For example, while recumbent dogs have been mentioned, it should be appreciated that generally any animal that may have difficulty moving could utilize aspects of any of the disclosed features.

It is preferred that the apparatus be safe, cost effective, and durable.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the apparatus.

Methods can be practiced which facilitate use, manufacture, assembly, maintenance, and repair of an apparatus, which accomplish some or all of the previously stated objectives.

The apparatus can be incorporated into systems or kits, which accomplish some or all of the previously stated objectives.

According to at least some aspects of the present disclosure, an apparatus comprises a frame; a bed positioned relative to the frame, said bed comprising a mattress; wherein the bed is movable relative to the frame in at least a first plane and a second plane, wherein the first and second planes are different from one another.

According to at least some aspects of some embodiments of the present disclosure, the bed is connected to the frame by at least a first rotatable axis and a second rotatable axis.

According to at least some aspects of some embodiments of the present disclosure, the apparatus further comprises a first actuator operatively positioned between the bed and the frame and a second actuator operatively positioned between the bed and the frame.

According to at least some aspects of some embodiments of the present disclosure, the first actuator moves the bed relative to the frame about the first rotatable axis and the second actuator moves the bed relative to the frame about the second axis.

According to at least some aspects of some embodiments of the present disclosure, the first and second axes are positioned approximately 90-degrees relative to one another.

According to at least some aspects of some embodiments of the present disclosure, the bed is movable to the mattress in a plurality of planes.

According to at least some aspects of some embodiments of the present disclosure, the apparatus further comprises a plurality of actuators positioned between the bed and the frame.

According to at least some aspects of some embodiments of the present disclosure, the apparatus further comprises a fulcrum positioned between the bed and the frame, and wherein the plurality of actuators configured to move the bed in any number of planes about the fulcrum.

According to at least some aspects of some embodiments of the present disclosure, the apparatus further comprises expansion/contraction/inflation/deflation members positioned between the bed and the frame, said expanding/contracting/inflating/deflating members able to expand/contract/inflate/deflate to provide movement to the bed and a patient relative to the static frame.

According to at least some aspects of some embodiments of the present disclosure, the expanding/contracting/inflating/deflating members comprises a plurality of expanding/contracting/inflating/deflating elements that are able to be expanded/contracted/inflated/deflated individually to provide varying movement to the bed and patient in multiple planes.

According to still additional aspects of the disclosure, an oscillating/rotating/rocking dog bed comprises a substantially static support frame; a dynamic bed movably connected to the substantially static support frame, the dynamic bed comprising a surface configured to allow an animal to rest on, wherein the dynamic bed movable relative to the substantially static support frame in at least two distinct planes; and a movable member positioned relative to the dynamic bed and configured to move the dynamic bed in the at least two distinct planes relative to the substantially static support frame.

According to at least some aspects of some embodiments of the present disclosure, the oscillating/rotating/rocking bed further comprises a fulcrum operatively connected to the substantially static support frame and the dynamic bed to allow movement in the at least two distinct planes.

According to at least some aspects of some embodiments of the present disclosure, the oscillating/rotating/rocking member comprises an actuator to move the bed in at least two distinct planes.

According to at least some aspects of some embodiments of the present disclosure, the oscillating/rotating/rocking member comprises a plurality of actuators, with at least two of the actuators being linear actuators oriented in the at least two distinct planes.

According to at least some aspects of some embodiments of the present disclosure, the oscillating/rotating/rocking bed comprises expanding/contracting/inflating/deflating members.

According to at least some aspects of some embodiments of the present disclosure, the oscillating/rotating/rocking bed further comprises a remote control operatively connected to the movable member to activate the movable member in the at least two distinct planes.

According to still additional aspects of the disclosure, a dynamic dog bed system comprises a substantially static frame; a dynamic dog bed operatively connected to the substantially static frame; an electronically activated moving system positioned relative to the dynamic dog bed; and a control (local or remote) connected to the electronically activated moving system to activate the same, wherein the activation of the electronically activated moving system causes the dynamic dog bed to move in at least two distinct planes relative to the substantially static frame.

According to at least some aspects of some embodiments of the present disclosure, the control (local or remote) is connected wired or wirelessly to the electronically activated moving system.

According to at least some aspects of some embodiments of the present disclosure, the electronically activated moving system comprises: one or more electronic actuators to move the dynamic dog bed about a fulcrum positioned between the dynamic dog bed and the substantially static frame; one or more expanding/contracting/inflating/deflating elements positioned to move the dynamic dog bed upon a constant or varied expansion/contraction/inflation/deflation thereof; one or more electronic actuators operated in a pattern to move the dynamic dog bed; or some combination thereof.

According to at least some aspects of some embodiments of the present disclosure, the system further comprises a timing system (timer) connected to a processor to control operation of the electronically activated moving system.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a depiction of an oscillating/rotating/rocking dog bed with a dog positioned thereon according to aspects and/or embodiments of the present disclosure.

FIG. 2 is another depiction of an oscillating/rotating/rocking dog bed with a dog positioned thereon according to aspects and/or embodiments of the present disclosure.

FIG. 3A is a depiction of the movement of the bed of the dog bed in at least a first plane or about a first axis.

FIG. 3B is similar to FIG. 3A but showing the dog bed rotating about a different axis, such as one transverse to the axis in FIG. 3A.

FIG. 4 is a depiction of an oscillating/rotating/rocking dog bed showing examples of controls and power.

FIG. 5 is another depiction of an oscillating/rotating/rocking dog bed showing examples of controls and power.

FIG. 6 is an enlarged view of an example of control system of a user interface for an oscillating/rotating/rocking dog bed, such as any of those disclosed herein.

FIG. 7 is a depiction showing a dog in a different position on an oscillating/rotating/rocking dog bed.

FIG. 8A is a view similar to FIG. 7 showing a dog on an oscillating/rotating/rocking dog bed.

FIG. 8B is a view of another position for the dog on an oscillating/rotating/rocking dog bed.

FIG. 9 is a depiction of an oscillating/rotating/rocking dog bed including a fulcrum about which the dog bed is movable about multiple planes and/or axes.

FIG. 10 is a depiction of an oscillating/rotating/rocking dog bed including a plurality of movable actuators to move the bed about a plurality of planes and/or axes.

FIG. 11 is another depiction of an oscillating/rotating/rocking dog bed including a plurality of movable actuators to move the bed about a plurality of planes and/or axes.

FIG. 12 is a depiction of an oscillating/rotating/rocking dog bed including one or more expanding/contracting/inflating/deflating members to move the bed about a plurality of planes and/or axes.

FIG. 13 is a depiction of the dog bed with specifications.

FIG. 14 is another depiction of the dog bed with specifications.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Referring now to the figures, a movable dog bed 10 is shown. The various aspects and/or embodiments disclose a pet (hospital or home) bed that gently and continually rocks or otherwise moves in multiple planes to move the body of an animal, such as a dog, into different position over time. The advantage to this is that the patient's skin and muscle receive adequate blood flow without the need for a care giver to actually move the animal. The continuous nature of the movement allows for more consistent and extensive relief from pressure-related blood flow complications than can be performed by the caregiver.

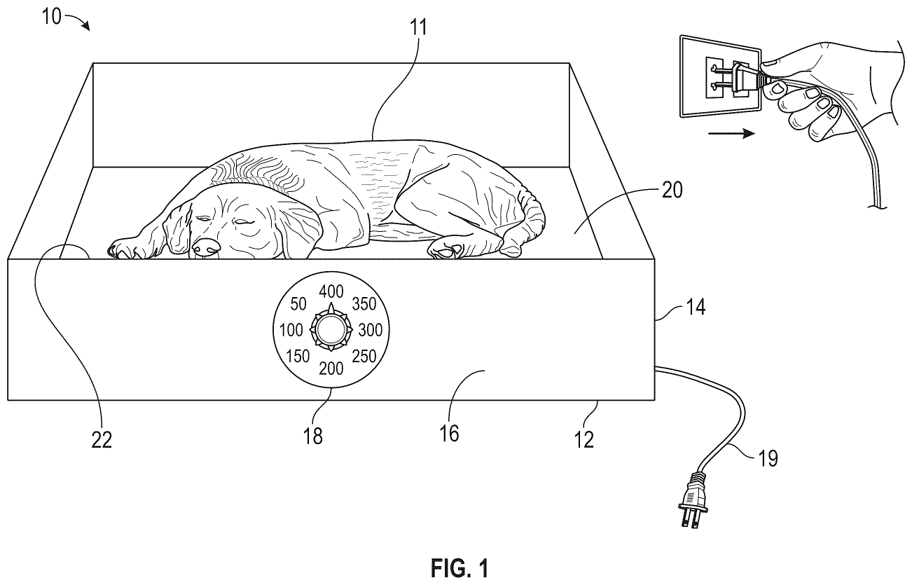

For example, FIG. 1 shows a movable dog bed 10 according to at least some aspects of some embodiments of the present disclosure. The bed 10 includes a frame 12, which is shown to be a housing 14 with walls. A dog bed portion 20 is operatively connected to the frame 12. The dog bed 20 supports a dog 11 and may include a mattress or other comfort member, at least according to some aspects of some embodiments.

As will be understood, the bed portion 20 is movable relative to the frame 12. The bed 20 may be movable about one or more planes or axes to provide the movement to the patient 11 (e.g., dog) on the bed to increase the blood flow to the various portions of the patient.

Additional components shown in FIG. 1 include a control 18, which may also be referred to as a user interface, human-machine interface, or otherwise. The control 18 can set the motion of the bed 20 relative to the frame 12, can set the timer, or can otherwise control movements of the components of the system 10. A power source 19 is shown to provide power to the bed 10. The power source 19 is shown to be a power cord that can be connected to a power outlet (see, e.g., upper right), but this is not the only power source envisioned. As will be understood, the power to the system can be wired or wireless.

The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel-cadmium battery (“NiCd”), a lithium-ion battery, or a lithium-ion polymer (“LiPo”) battery. Careful attention should be taken when using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

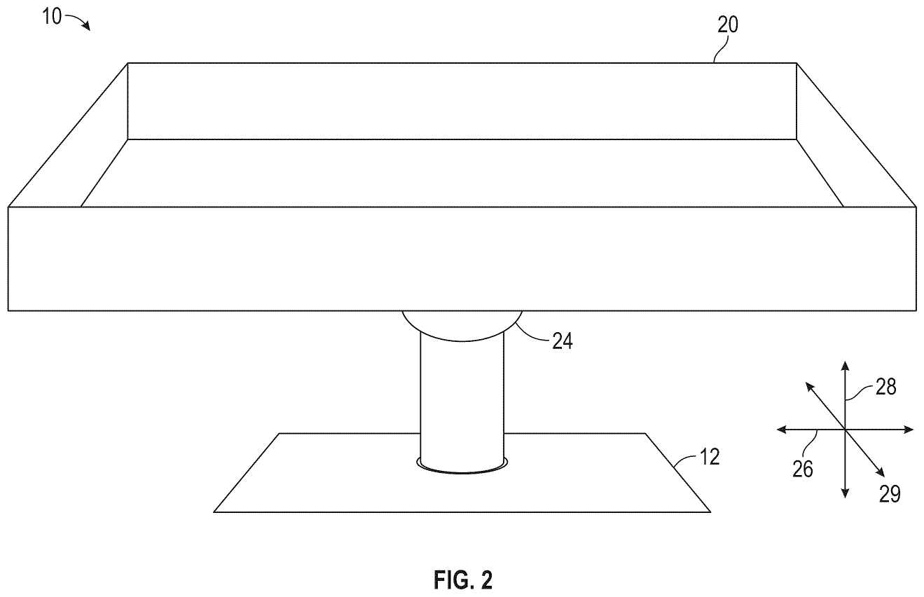

FIG. 2 shows additional aspects of additional embodiments of a dog bed 10. Again, the dog bed system 10 includes a frame 12 and a bed 20. However, in this figure, the bed 20 is shown positioned and connected to a fulcrum 24. The fulcrum is a pivot point for the bed 20 relative to the frame 12, which can allow the bed 20 to be moved about multiple axes and/or multiple planes to provide the necessary movement. For example, the figure shows x-, y-, and z-axes. The fulcrum provides one point for the bed 20 to move about the fulcrum to move on one or more of these axes to urge the blood flow of the patient (i.e., dog 11) resting on the bed 20.

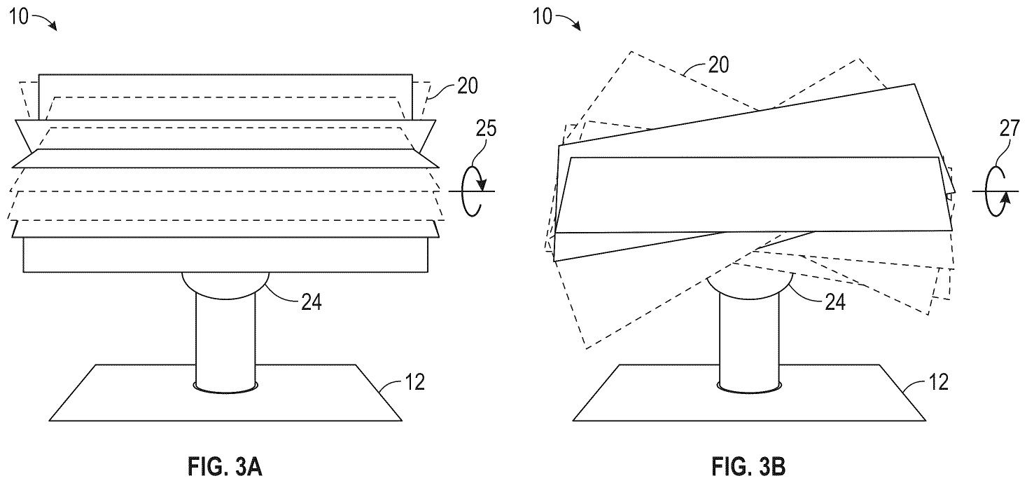

FIGS. 3A and 3B show additional aspects of the dog bed 10 shown in FIG. 2. FIG. 3A shows movement of the dog bed 20 about a first plane/axis via the fulcrum 24. This is shown by the arrow 25 in the figure. FIG. 3B is a view of FIG. 3A rotated 90°, showing movement about a different plane/axis. This is shown by the arrow 27 in the figure. Therefore, the figures together show that the bed 20 is able to move about the fulcrum in multiple planes/axes/directions, which will provide varying movement for a patient resting on the bed 20. It should be noted that the axes shown in FIG. 2 are not the only axes/planes that the bed is able to move, and there can be wavelike movement that transverses multiple planes. There can also be rocking movement. The exact type and orientation of movement is not to be limiting on the bed.

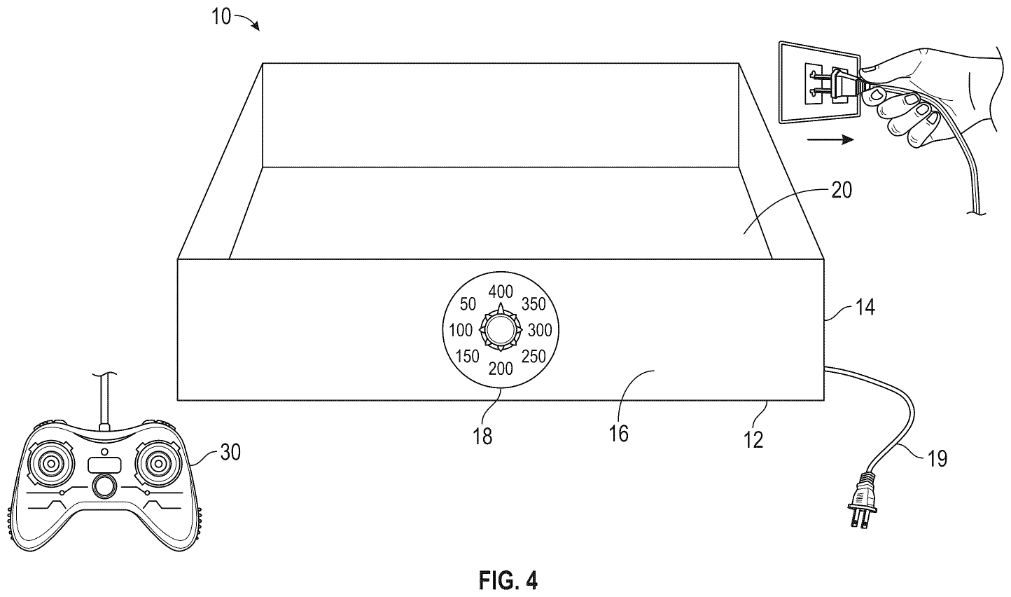

FIG. 4 is another depiction similar to FIG. 1. The figure further shows controls, including onboard controls 18 and remote controls 30 to control the movement of the bed 20. As indicated, the controls, whether onboard or remote, can control one or more aspects of the movement of the bed. This can include, for example, the tilt angle of the bed and/or the speed of the movement of the bed. The controls allow alteration of both the tilt angle and speed of movement for the bed 10.

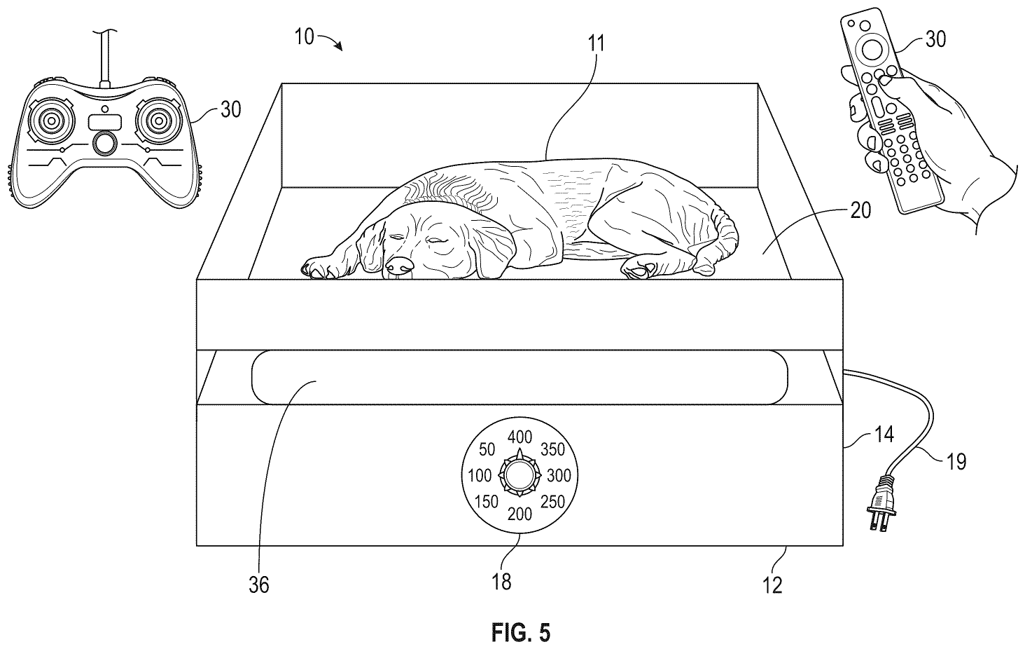

FIG. 5 shows additional controls for additional types of oscillating/rotating/rocking dog bed 10. The dog bed in FIG. 5 is oscillating/rotating/rocking via one or more expanding/contracting/inflating/deflating members 36. Such expanding/contracting/inflating/deflating members could be filled with air, water, or other fluids, and the movement of the bed 20 relative to the frame 12 is caused by a variation to one or more of the expanding/contracting/inflating/deflating members.

In such a configuration, the movement, including speed, duration, amount of movement, etc. could be controlled by the onboard control 18 or by one or more remote controls 30. The upper left remote control 30 is a video game like controller that could be used to manipulate, activate, or end the movement of the bed. The upper right shows a TV-like remote that can be preprogrammed with various settings, styles, patterns, sequences, or the like, which can control the movement of the bed via one or more expanding/contracting/inflating/deflating members.

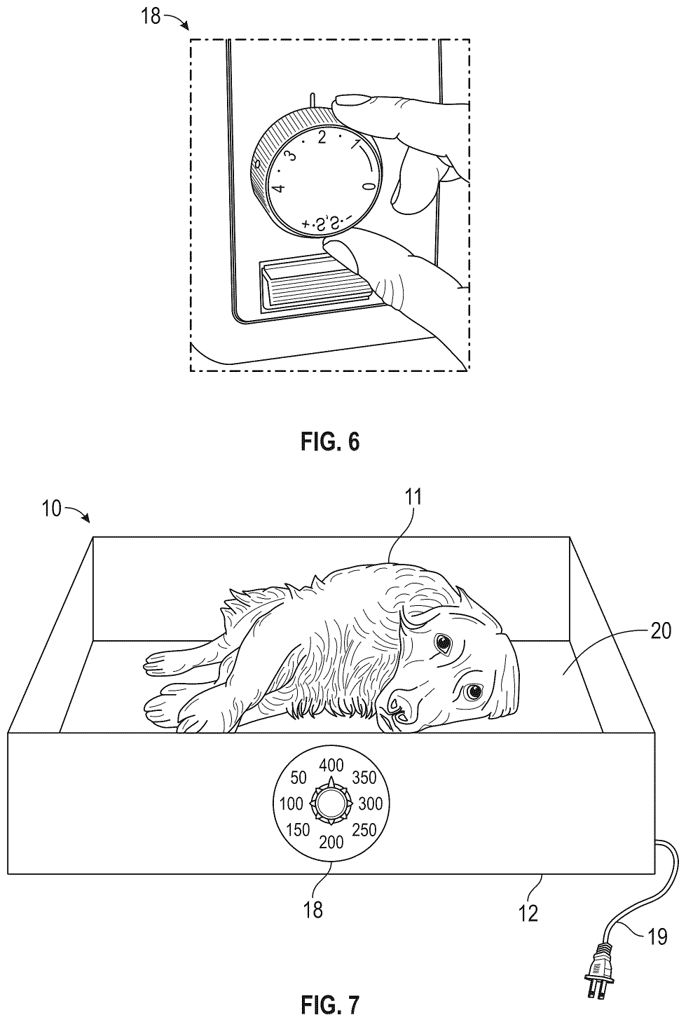

FIG. 6 shows yet another version of a controller 18. This is an onboard style controller that can control the movement of the bed, such as via preset conditions. This can include setting the cycle time of the system, e.g., wherein 1 cycle=1 minute, with the settings set to operate the movable bed in 5-cycle (minute) intervals.

The controls, whether onboard or remote, may be connected to a processor having a non-transitory computer readable medium to store instructions for the movement of the bed. In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

As noted, the oscillating/rotating/rocking dog bed 10 will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The memory may store different operating conditions, which may relate to the operation of the oscillating/rotating/rocking bed. For example, the operating conditions may include different levels of movement, such as low, medium, high, as well as generally infinite in-between settings. These settings control how much movement, or the speed of movement, of the bed during operation. In addition, the memory and/or operating conditions can be in the form of preset patterns or programs, wherein the movement of the bed is moved through the pattern. The pattern or program can a consistent movement or can include varying movements during the course of the program to provide variable movement to the animal on the bed. For example, an example program could include a first setting wherein the movement is in a single plane at a single speed. After a preset time, the program could change to one or more different speeds and/or planes of movement to provide variable movement to aid in the blood flow, activation of neural networks, acupressure stimulation, trigger point stimulation, and massage for the generally non-ambulatory animal. The processor, timer, and control could indicate which of the saved programs are to be operated and then the system will operate generally autonomously until the program has completed all aspects. This could also be preset, such as with a timer/clock. For example, the system could be set to automatically turn on at a selected time of day or after a set duration (e.g., every 4-hours), such that a user need not remember to turn on or operate the system. Still further variations and/or alternatives should be considered.

In addition, as noted, the controller 18 may be remote. For such remote controls, it should be appreciated that the remote control is in wireless communication with the bed 10 to provide instructions thereto. This can be done via networks, WiFi, Bluetooth, NFT, etc. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (“VoIP”). Websites can use TLS to secure all communications between their servers and web browsers.

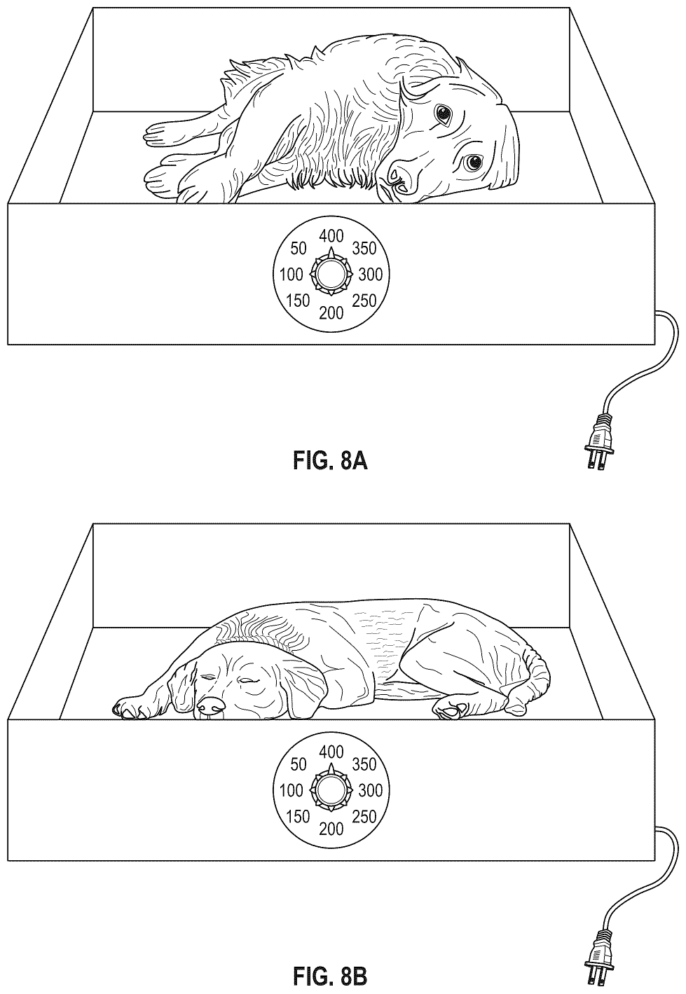

FIGS. 7, 8A, and 8B show a dog bed system 10 similar to that shown in FIG. 1 with patients (i.e., dogs) in various positions on the bed. This shows that the bed is not limiting to the patient and can provide movement to patients having a number of issues, conditions, and/or maladies. The key is that the movement of the bed will encourage better blood flow to the various portions of the animal and activate various neural networks (proprioception, touch, pressure receptors), provide acupressure stimulation, trigger point pressure, or massage to mitigate health issues that can arise from non-movement.

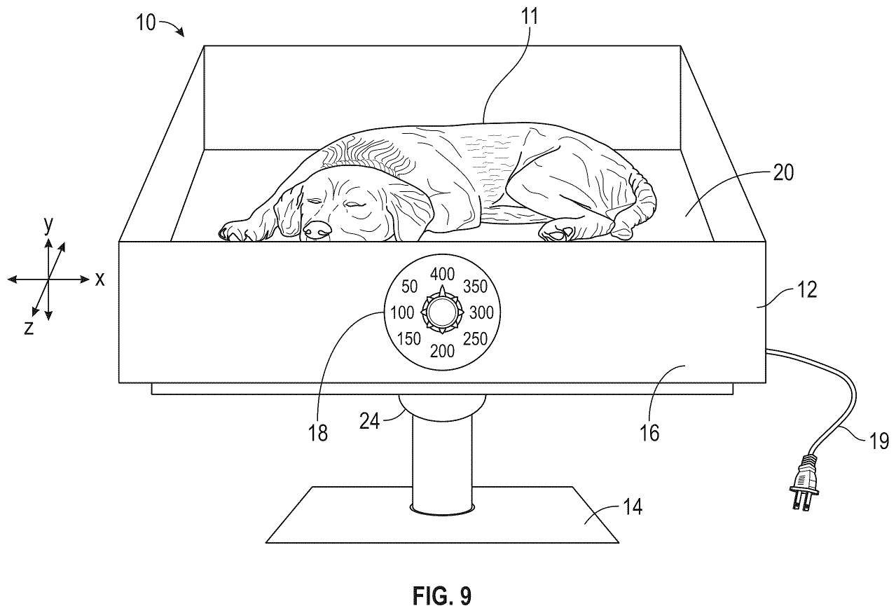

Moving to FIG. 9, the dog bed 10 includes a frame 12 that includes a base 14. The frame includes walls 16. An onboard control 18 is shown on one of the walls 16 of the bed. A power cord 19 also connects the bed to allow power connection, such as via an outlet. The bed 20 is connected to the frame via a single fulcrum 24. Therefore, the bed 20 will be able to move about multiple planes/axes via the fulcrum to impart movement to the patient 11 on the bed, which will encourage the desired blood flow.

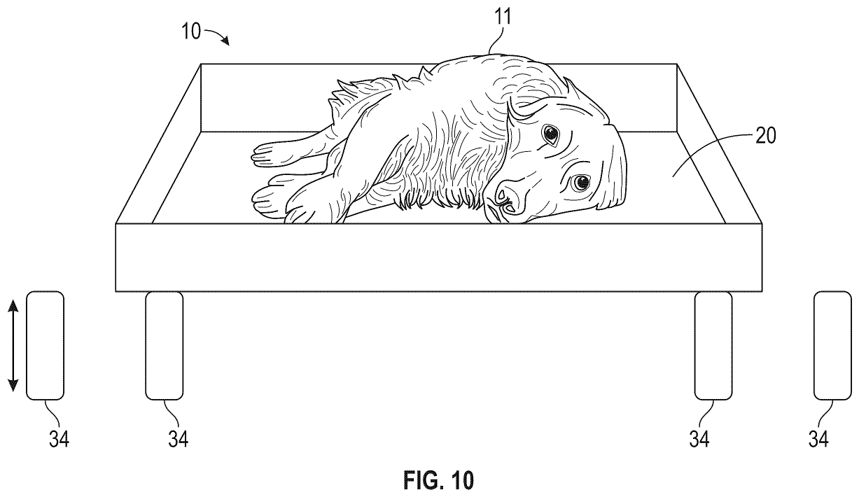

FIG. 10 depicts another version of the oscillating/rotating/rocking dog bed 10. In FIG. 10, one or more actuators 34 (hydraulic, pneumatic, electric, or some combination thereof) are operatively connected to the dog bed 20 to provide movement thereto. According to some aspects of some embodiments, the actuators are linear actuators, wherein alternating extension and retraction of the actuators will provide rocking, wavelike movement, or other movement about multiple planes/axes for the patient 11. According to additional embodiments, one or both ends of one or more actuators may be rotatably connected to provide additional movement to the bed and patient positioned on the bed.

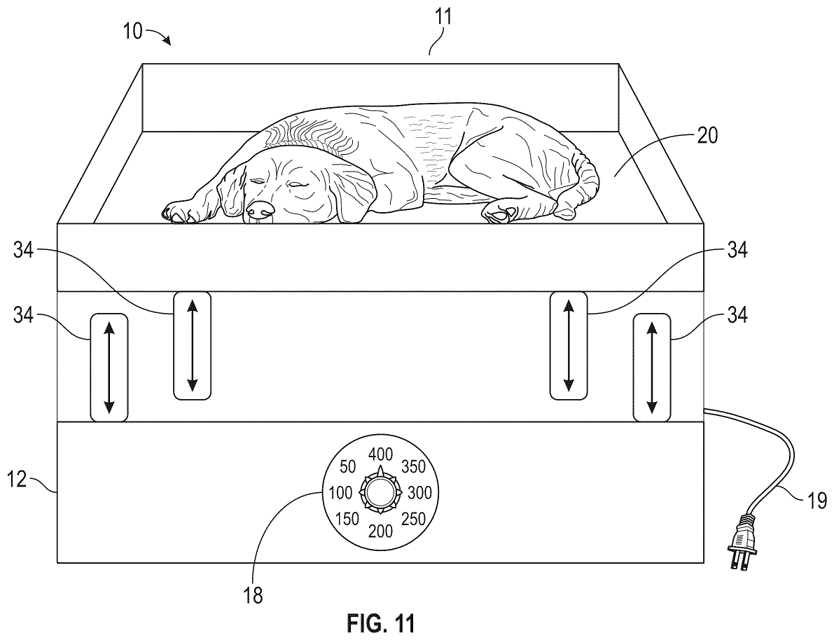

FIG. 11 is another version of the oscillating/rotating/rocking dog bed 10 using actuators 34. The actuators may be positioned between the bed 20 and a frame 12 to provide varying movement to the bed and the patient positioned thereon. The number, location, and/or type of actuators can be varied and should not be limiting on the disclosure.

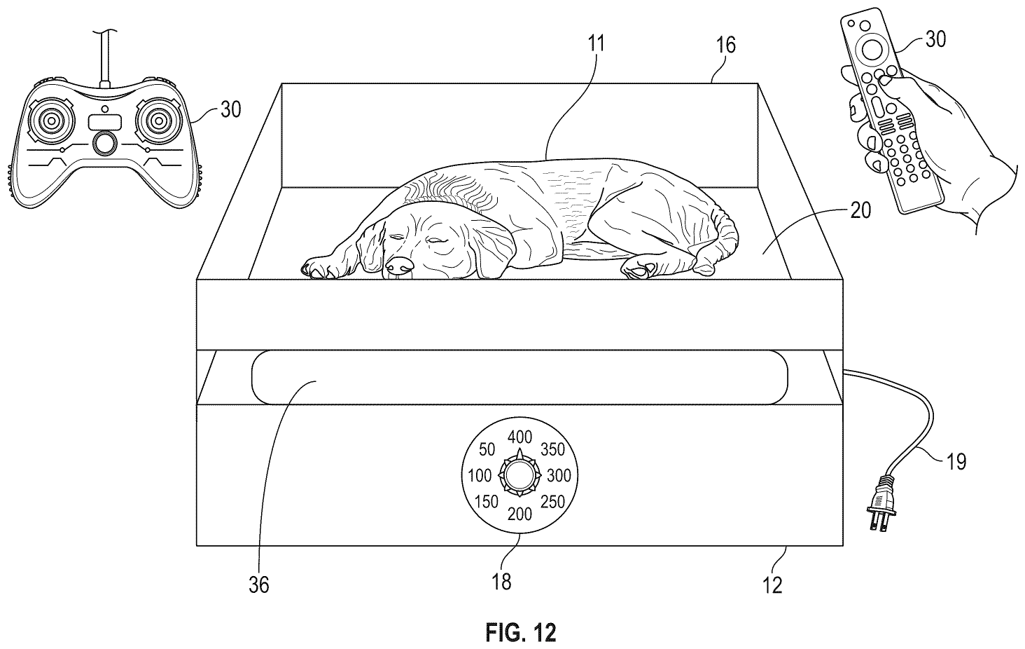

FIG. 12 is another version of the oscillating/rotating/rocking dog bed 10. The dog bed 10 in the figure includes one or more expanding/contracting/inflating/deflating members 36 to provide movement to the bed portion 20 of the bed 10. The expanding/contracting/inflating/deflating members 36 can be manipulated via air, water, other fluid, or power to add and remove the surface and subsurface pressure to provide movement at different locations of the bed to provide the movement thereto. In such an instance, the expanding/contracting/inflating/deflating members are like ballasts. In other configurations, the expanding/contracting/inflating/deflating members may be filled with water, much like a waterbed, and the water is moved from one location to another to vary the thickness of the inflatable, which will impart the movement to the bed resting thereon or otherwise operatively connected thereto.

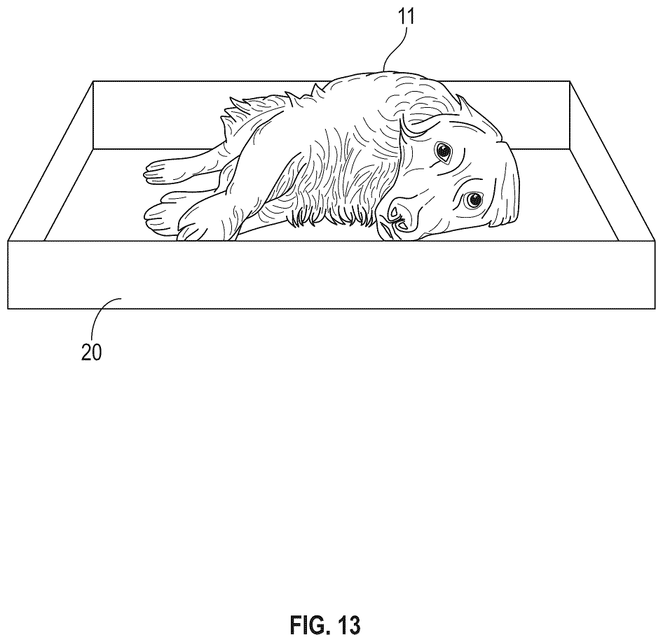

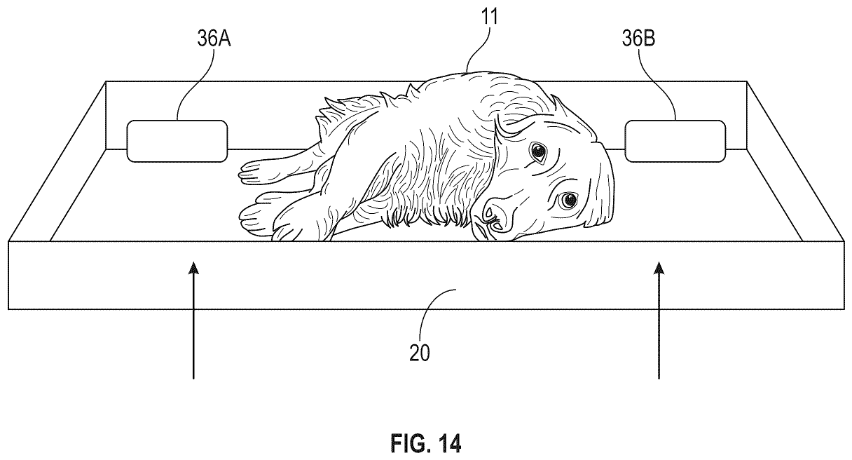

FIGS. 13 and 14 provide some non-limiting specifications that may aid in the movement for the patient 11 via the bed. According to at least some aspects of some embodiments, the bed supports dogs of various sizes, up to and including 200 lbs. In addition, it may be desirable, according to at least some aspects of some embodiments, to have the bed movable to til up to 75°-90° in all planes, axes, or general directions. To aid in mitigating the patient 11 from sliding off the bed, the bed 20 may include sidewalls. The sidewalls may be of variable height to hold different sized patients. In addition, material may be applied to the bed to mitigate sliding of the patient. This can include, for example, non-sliding grips, like rubber materials.

In any of the depictions, including any aspect of any embodiment, there may be motors included to provide the movement for the bed. The engine or motor is designed to convert one form of energy into mechanical energy. Potential nonlimiting examples of engines or motors include electric motors (e.g., DC motors, AC motors, self-commutated-motors including brushed and brushless DC motors,), physically powered motors, pneumatic motors, hydraulic motors, or the like. The engine or motor may be run at multiple speeds and various motor parameters including, but not limited to, power consumption, speed, thrust, torque, motor phase current, motor back EMF, engine noise or the like to achieve a practical affect consistent with the objects of the present disclosure. These parameters may be calculated, monitored, and saved by an intelligent control associated with the motor so that efficiencies are gained when using the engine or motor for standard or repetitive tasks.

In some embodiments, the electric motor is driven by a motor driver or other power source, which is coupled to the electric motor via associated wires. A control mechanism, such as an air pump, electrical switch, or the like, may be provided for controlling the motor driver or power supply. For example, a control circuit may control and adjust the rotational speed of electric motor and a magnetic drive member. The control circuit may also be configured to actuate the electric motor when a pumping mechanism is magnetically coupled to the driving mechanism and to act as a safety switch to stop actuation of the electric motor when the pumping mechanism is not magnetically coupled to the driving mechanism or when there is a relatively weak magnetic coupling between the pumping mechanism and the driving mechanism, suggesting misalignment.

The electric motor may be covered by a magnetically permeable material, such as steel, which is typically attached to and covers opposite ends of the electric motor to shield the electric motor from magnetic flux.

Therefore, the oscillating/rotating/rocking dog bed has been disclosed. The dog bed may include a number of variations, alternatives, and/or changes that are not explicitly disclosed, but which constitute parts of the disclosure. In addition, it should be contemplated that any aspect of any embodiment disclosed could be combined with any of the other aspects of any embodiment to result in additional embodiments not explicitly disclosed herein.

1. An apparatus, comprising:
a frame;
a bed positioned relative to the frame, said bed comprising a mattress;
wherein the bed is movable relative to the frame in at least a first plane and a second plane, wherein the first and second planes are different from one another.

2. The apparatus of claim 1, wherein the bed is connected to the frame by at least a first rotatable axis and a second rotatable axis.

3. The apparatus of claim 2, further comprising a first actuator operatively positioned between the bed and the frame and a second actuator operatively positioned between the bed and the frame.

4. The apparatus of claim 3, wherein the first actuator moves the bed relative to the frame about the first rotatable axis and the second actuator moves the bed relative to the frame about the second axis.

5. The apparatus of claim 2, wherein the first and second axes are positioned approximately 90-degrees relative to one another.

6. The apparatus of claim 1, wherein the bed is movable to the mattress in a plurality of planes.

7. The apparatus of claim 1, further comprising a plurality of actuators positioned between the bed and the frame.

8. The apparatus of claim 7, further comprising a fulcrum positioned between the bed and the frame, and wherein the plurality of actuators configured to move the bed in any number of planes about the fulcrum.

9. The apparatus of claim 1, further comprising an inflatable member positioned between the bed and the frame, said inflatable member able to inflate to provide movement to the bed relative to the static frame.

10. The apparatus of claim 9, wherein the inflatable member comprises a plurality of inflatable portions that are able to be inflated individually to provide varying movement to the bed in multiple planes.

11. An oscillating/rotating/rocking dog bed, comprising:
a substantially static support frame;
a dynamic bed movably connected to the substantially static support frame, the dynamic bed comprising a surface configured to allow an animal to rest on, wherein the dynamic bed movable relative to the substantially static support frame in at least two distinct planes; and
a movable member positioned relative to the dynamic bed and configured to move the dynamic bed in the at least two distinct planes relative to the substantially static support frame.

12. The oscillating/rotating/rocking dog bed of claim 11, further comprising a fulcrum operatively connected to the substantially static support frame and the dynamic bed to allow movement in at least two distinct planes.

13. The oscillating/rotating/rocking dog bed of claim 11, wherein the movable member comprises an actuator to move the bed in at least two distinct planes.

14. The oscillating/rotating/rocking dog bed of claim 11, wherein the movable member comprises a plurality of actuators, with at least two of the actuators being linear actuators oriented in at least two distinct planes.

15. The oscillating/rotating/rocking dog bed of claim 11, wherein the movable member comprises an inflatable member.

16. The oscillating/rotating/rocking dog bed of claim 11, further comprising a remote control operatively connected to the movable member to activate the movable member in at least two distinct planes.

17. A dynamic dog bed system, comprising:
a substantially static frame;
a dynamic dog bed operatively connected to the substantially static frame;
an electronically activated moving system positioned relative to the dynamic dog bed; and
a remote control connected to the electronically activated moving system to activate the same, wherein the activation of the electronically activated moving system causes the dynamic dog bed to move in at least two distinct planes relative to the substantially static frame.

18. The dynamic dog bed system of claim 17, wherein the remote control is connected wired or wirelessly to the electronically activated moving system.

19. The dynamic dog bed system of claim 17, wherein the electronically activated moving system comprises:
a. one or more electronic actuators to move the dynamic dog bed about a fulcrum positioned between the dynamic dog bed and the substantially static frame;
b. one or more expanding/contracting/inflating/deflating members positioned to move the dynamic dog bed upon a constant or varied inflation thereof;
c. one or more electronic actuators operated in a pattern to move the dynamic dog bed; or
d. some combination thereof.

20. The dynamic dog bed system of claim 17, further comprising a timer connected to a processor to control operation of the electronically activated moving system.
